(19) United States
(12) Patent Application Publication
(10) Pub. No.: US 2018/0189399 A1
(43) Pub. Date: Jul. 5, 2018

(54) SYSTEMS AND METHODS FOR IDENTIFYING AND CHARACTERIZING SIGNALS CONTAINED IN A DATA STREAM

(71) Applicant: Google Inc., Mountain View, CA (US)

(72) Inventors: Alexandrin Popescul, San Francisco, CA (US); Matt Colen, Palo Alto, CA (US); Vladimir Ofitserov, Foster City, CA (US)

(21) Appl. No.: 15/394,586

(22) Filed: Dec. 29, 2016

(51) Int. Cl. G06F 17/30; G06F 17/18; G06N 99/00

(52) U.S. Cl. CPC G06F 17/30867; G06N 99/005; G06F 17/18; G06F 17/30554

(57) ABSTRACT

Methods, systems, and apparatus, including computer programs encoded on computer storage media, for identifying and characterizing signals contained in a data stream. One of the methods includes: obtaining an historical time distribution of event counts associated with a topic for a relevant time period; extracting a predictable portion of the historical time distribution of event counts to produce a residual event count time distribution including residual event counts at successive times; determining a residual triggering threshold based on the residual event count time distribution; and taking an action when a residual event count exceeds the residual triggering threshold. The action can include providing a notification to a user of a spike in event counts associated with the topic.

### BACKGROUND

### Technical Field

This specification relates to systems and methods for identifying and characterizing signals contained in a data stream, such as a signal contained in a time series of a data stream over a relevant time period where the data stream is associated with a topic.

### Background

Individuals use devices to make digital recordings of many aspects of their lives and of more and more events and topics. Such individuals make digital recordings using a variety of devices such as mobile phones, tablets, laptops or desktops, via the internet of things, and using cameras or other sensors such as wearable sensors. Thus, one can learn about developing events or views as they are reflected in digital media. Indeed, there is a need, and an opportunity, to detect developing events, such as developing news, accurately and early via digital media and to be able to provide such information to users.

### SUMMARY

This specification describes technologies for identifying and characterizing signals contained in a data stream, such as a signal contained in a time series of a microblog count for microblogs associated with a query over a relevant time period.

In general, one innovative aspect of the subject matter described in this specification can be embodied in methods that include the actions of: obtaining an historical time distribution of event counts associated with a topic for a relevant time period; extracting a predictable portion of the historical time distribution of event counts to produce a residual event count time distribution including residual event counts at successive times; determining a residual triggering threshold based on the residual event count time distribution; and taking an action when a residual event count exceeds the residual triggering threshold. The action can include providing a notification to a user of a spike in event counts associated with the topic. In one embodiment, the event can be a microblog and the action can be forwarding data to display microblog data as part of search results.

Another innovative aspect of the subject matter described in this specification can be embodied in methods that include the actions of: receiving a query; obtaining a microblog count time series for microblogs associated with the query for a relevant time period; extracting a predictable portion of the microblog count time series to produce a residual microblog count time series for the relevant time period, the residual microblog count time series including residual microblog counts at successive times; determining a residual triggering threshold based on the residual microblog count time series; and forwarding data to display microblog content as part of search results for a given query when a residual microblog count exceeds the residual triggering threshold.

The foregoing and other embodiments can each optionally include one or more of the following features, alone or in combination. In particular, one embodiment includes all the following features in combination. The method can include using a machine learning model to predict the predictable portion of the microblog count time series. The microblog count can be a count of tweets provided on the Twitter platform. The method can stop inserting microblog content as part of search results for the query, as a result of a method described in this specification, a specified time after the excess microblog count falls below the threshold. The relevant time period for the microblog count time series can be between 1 and 7 days. Determining a residual triggering threshold can be based at least in part on a median of the residual time series and a measure of the variance of the residual time series. The method can further include communicating to a user a confidence metric that the residual microblog count reflects an event for which a user should be notified, the confidence metric based at least in part on the degree to which the residual microblog count exceeds the triggering threshold. The method can further include incorporating user interaction with provided microblog content in determining whether to provide additional microblog content as part of search results for a query. The method can further include restricting the microblog count time series to microblogs from a particular location.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. By receiving news of a developing event earlier and more accurately, users get their information more efficiently and in a more timely manner. Depending on the context, timely receipt of developing news and the wisdom of the crowd can be highly advantageous. In addition, delivering timely and accurate notification of developing events can reduce the number of searches conducted looking for information about the developing events saving compute resources and freeing up network bandwidth for more productive purposes. Furthermore, microbloggers and other publishers reap rewards because their content can immediately reach a wide, engaged, and appropriate audience. This encourages more people and organizations to microblog, and to do so more quickly and accurately, which is advantageous for information and communication generally.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic of a system for identifying and characterizing signals contained in a data stream.

FIG. 2 is a flowchart of a method for identifying and characterizing signals contained in a data stream.

FIG. 3 is a flowchart of an alternative method for identifying and characterizing signals contained in a data stream.

FIG. 4 shows two graphs of event count times series data for events that match a query.

FIG. 5 shows two graphs of event count times series data for events that match another query and where the graphs reveal the avoidance of triggering for slower increases when using the method of FIG. 2.

FIG. 6 is an example of an event carousel embedded in a search results page provided in response to a query.

Like reference numbers and designations in the various drawings indicate like elements.

### DETAILED DESCRIPTION

It is challenging to determine when to notify a user of a search engine platform or other online platform of a developing event. Such a platform should notify a user as early as possible while being accurate, providing the user with context and not providing false notifications.

Embodiments described in this specification provide a machine learning approach that models a history of near real-time event counts, e.g., tweet counts, matching a given query to decide when a spike occurs. An advantage of this approach is earlier, and more accurate detection of breaking news.

More specifically, triggering a notification of a spike in near real-time event counts (e.g., tweet counts) based on a raw time series can be improved when a model of such time series is available. As noted, trending activity that should trigger an action, such as a notification to a user, is hard to predict. Embodiments described in this specification solve this problem by first predicting what a data count, e.g., a microblog count, would have been under “regular” circumstances, i.e. embodiments extract the predictable part of a microblog count time series, and then apply triggering logic based on how the actual counts differ from their predicted counts. This approach adjusts for predictable time series fluctuations, such as time of the day. For example, this approach excludes time of day variations from contributing to triggering decisions so that an expected increase in activity, e.g., in the mornings, would not be mistaken for a spike.

To build such a model, embodiments described in this specification collect training data and use a regularized regression model to produce an interpretable predictive model. Such a predictive model gives an improved spike detection mechanism.

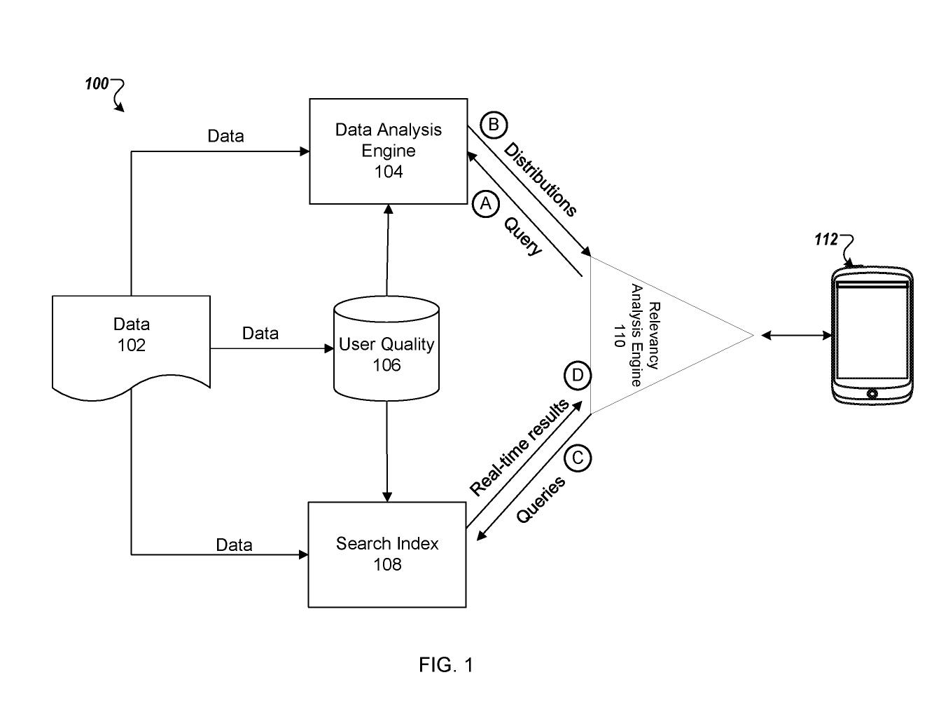

FIG. 1 shows an example system 100 for detecting and characterizing signals in a data stream. The system receives, from a data source such as a microblog source, data such as microblog content, e.g., tweets and retweets, 102 which is fed into 3 different parts of the system: a data analysis engine 104, user quality database 106 and a search index 108. The data analysis engine 104 generates a time series for data, e.g., for microblogs, associated with a topic or query. The user quality 106 database determines a user quality score and a user location for users that author the microblogs. The search index 108 indexes the microblog content. The system further includes a relevancy analysis engine 110.

In operation, a user enters a query into a search engine using a computing device 112. The query is received by the relevancy analysis engine 110 (in some cases via a search engine front end). At step A, the relevancy analysis engine 110 forwards the query to the data analysis engine 104. At step B, the data analysis engine 104 returns to the relevancy analysis engine 110 a historical distribution of microblog counts, e.g., a time series of microblog counts for the query over a relevant time period such as the past several days, The data analysis engine 104 can also return to the relevancy analysis engine 110 data about the location of the relevant microblogs and associated hashtag data.

In certain embodiments described in this specification, a microblog, e.g., a tweet, is associated with a query when the microblog contains a substantive query word or a synonym of a substantive query word. However, in one embodiment, if the query includes more than one substantive word and a microblog only has one of the substantive words it would not be counted as associated with the query. For example, a microblog that only mentions Obama would not count for the query [Obama Trump]. Certain embodiments also eliminate non-substantive words. Substantive words can vary by context. For example, the query “the who”, in which the word “the” is unusually substantive.

In certain embodiments, the query from the relevancy analysis engine 110 to the data analysis engine 104 only considers the text of the query and text of the microblog. The response from the data analysis engine 104 informs the relevancy analysis engine 110 about many-dimensional patterns in the relevant microblogs. Knowing these patterns, the relevancy engine 110 issues a query to the search index 108 that could associate a microblog, e.g., a tweet, with the query because of a combination any of the following: timestamp of microblog, country from which the microblog was issued, hashtags in the microblog, entities (e.g. Joe Celebrity or the Olympics) mentioned in the microblog, sub-country location from which the microblog was issued, microblog usernames mentioned in the microblog, and words (unigrams) or phrases in the microblog.

Based on the distribution data received from the data analysis engine 104, the relevancy analysis engine 110 determines whether to take an action, e.g., notify a user, or include microblog content into search results provided by an associated search engine in response to a query. If the relevancy analysis engine 110 determines that microblog content should be included in search results in response to a user submitted query, the relevancy analysis engine 110 sends a query to the search index 108 and receives relevant microblog content in return.

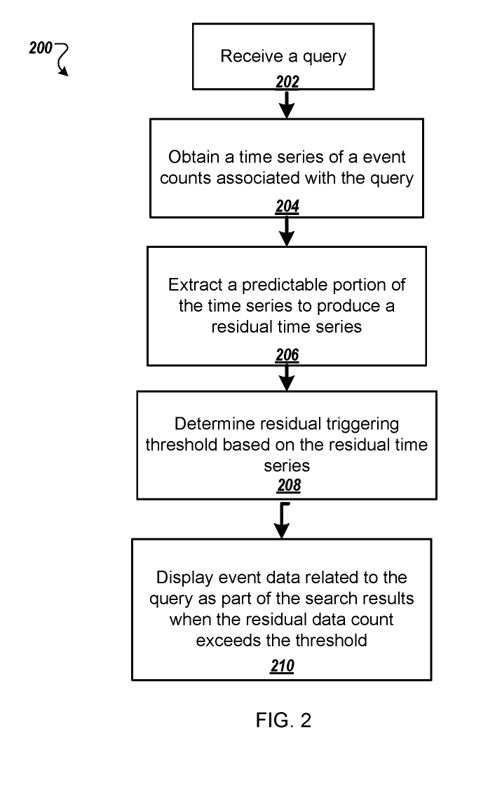

FIG. 2 is a flowchart of an example process 200 for detecting and characterizing signals in a data stream, e.g., a signal in a microblog count time series. For convenience, the process 200 will be described as being performed by a system of one or more computers, located in one or more locations, and programmed appropriately in accordance with this specification. For example, a system for detecting and characterizing signals in a data stream, e.g., the system 100 of FIG. 1, appropriately programmed, can perform the method 200.

One embodiment of the method includes receiving 202 a query, e.g., a query entered into a search engine by a user; obtaining 204 (e.g., from a data analysis engine) a microblog count time series for microblogs associated with the query for a relevant time period; extracting 206 (e.g., at a relevancy analysis engine) a predictable portion of the microblog count time series to produce a residual time series, the residual time series including residual microblog counts at successive times; determining 208 (e.g., at the relevancy analysis engine) a residual triggering threshold based on the residual time series; and forwarding for display 210 (e.g., by the relevancy analysis engine) data representing a microblog content as part of search results for the query when a residual microblog count exceeds the residual triggering threshold. In one embodiment, the microblog content is provided in a microblog carousel as part of the search results. In another embodiment, the microblog content is simply included in the search results.

Thus, certain embodiments described in this specification are related to the delay between something happening in the real word, e.g. a news event, and the time at which the relevancy analysis engine 110 determines that the system should take action such as provide a user with a notification. A timeline could progress as follows: a news event occurs; 5 minutes pass and a microblog count, e.g., a tweet count, associated with a query for the news event starts to rise; 10 minutes pass and a relevancy analysis engine 110 determines the system should take action (i.e., the relevancy analysis engine determines there is a “spike” in the microblog count for the relevant query relative to the count that is predicted); an associated search engine starts to show microblogs in search results responsive to the relevant query. Embodiments described in this specification shorten the time it takes the relevancy analysis engine to determine that the system should take action.

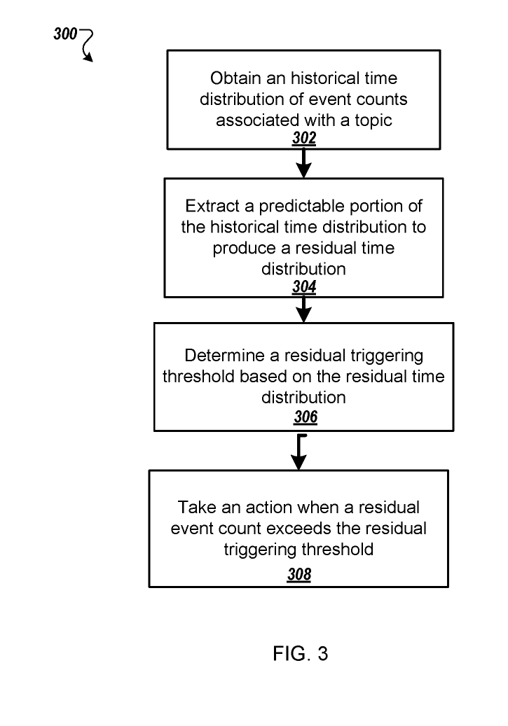

FIG. 3 is a flowchart of an alternative method for identifying and characterizing signals contained in an event data stream. The illustrated method 300 includes: obtaining 302 an historical time distribution of event counts associated with a topic for a relevant time period; extracting 304 (e.g., at a relevancy analysis engine) a predictable portion of the historical time distribution of event counts to produce a residual event count time distribution including residual event counts at successive times; determining 306 (e.g., at a relevancy analysis engine) a residual triggering threshold based on the residual event count time distribution; and taking 308 an action (e.g., at a relevancy analysis engine) when a residual event count exceeds the residual triggering threshold. In one embodiment, event count is the number of microblogs, e.g., tweets, created in a certain time interval (bucket) which match a query. “Event” in this example is creation of a relevant microblog. However, an event could also be the creation of other forms of social media, a scholarly article or other content reflecting a developing event.

As noted above, embodiments described in this specification collect training data and use a regularized regression model to produce an interpretable predictive model. One can use least absolute shrinkage and selection operator (LASSO) regression in deriving the prediction model. In statistics and machine learning, LASSO is a regression analysis method that performs both variable selection and regularization in order to enhance the prediction accuracy and interpretability of the statistical model it produces. To derive the prediction model one can collect a large number of different queries' time series over a period of time. Such historic datasets (which include attributes such as time series timestamps or global (query independent) time series of tweet counts) are the training set used to build machine learned models predicting next bucket microblog count for a given query.

Thus, embodiments described in this specification use a predictive model to anticipate the predictable portion of the near real-time event counts, e.g., to anticipate the predictable portion of a microblog count time series associated with a given query or topic.

In general, interpretability is desirable but not required. Models that are harder to interpret than LASSO can also be used in this context. Such less interpretable models can often give more accurate predictions, but can be harder to debug. For example, it is possible that a neural network can be used instead.

A time series is a series of values of a quantity obtained at successive times, often with equal intervals between them. In certain embodiments, microblog counts are collected in equal time intervals that can be referred to as buckets. The size of the bucket is a trade-off between precision and recall. The bigger the bucket the more confident an embodiment of a system is about the signal but the later an embodiment of a system will determine a spike in counts.

Embodiments of the system obtain, from the data analysis engine 104 of FIG. 1, a microblog count time series data such as a multi-day history of overlapping 60 minute buckets to produce 30 minute buckets where each 30-minute bucket includes a count of microblogs, e.g., tweets®, over a 30 minute period. In other words, the recorded counts are 60 minute counts, but written at 30 min intervals to develop a microblog count time series with 30 minute intervals.

An embodiment of the system then extracts the predictable portion of the time series (as provided by the predictive model described above) from the microblog count time series to produce a residual time series. The residual time series thus includes residual microblog counts at successive time intervals, e.g., in 30 minute buckets. This embodiment of the system then determines a triggering threshold based on the residual time series.

In one embodiment, the triggering threshold equals median'+x'*IQR', where median'=median(residuals), IQR'=the Interquartile Range(residuals), x' is a tuning parameter, residuals=[residual(−1), residual(−2), . . . , residual(−K)], residual(−i)=numerator(−i)−predicted_numerator(−i), i is in [1, . . . , K]; num buckets ago: i=1 is the most recent bucket, i=2 is the second most recent bucket. The number of buckets can be range, e.g., from 12 to 192 half hour buckets. In other embodiments, the size of the bucket can be varied, for example, from 1 minute to 2 hours. In further embodiments the interquartile range can be replaced with a different measurement of the variability of the microblog counts.

In certain embodiments, the tuning parameter x' is a constant. The tuning parameter is set so that the system triggers regularly for real events (but rarely if ever on spam such as ads for cheap hotels) and so that the system triggers close to the actual time of the event. Again, a trigger can be a variety of actions such as a notification of a user or inclusion of relevant microblog content in search results in response to a query. In one embodiment, the system balances false positives (indicating that an event is spiking on a microblog when such an event is not actually spiking) and false negatives (not indicating an event related spike is happening on a microblog when that event is actually spiking). If the system lowers the constant and thus the threshold, the system will trigger (e.g., notifications or inclusion of microblog content in search results) more aggressively. One can use human raters and historical data to set the tuning parameter. Using a repository of historical data, one can “replay time” with a given tuning parameter to see when the system would trigger, e.g., a notification, on a given query. Then, one can consider whether that tuning parameter is causing the system to trigger too early or too late based on knowledge of the actual timing and context of the event in question. One can use one tuning parameter on several hundred or several thousand queries and send all the resulting triggers to human raters. The human raters can point out triggers that are not accurate and how the triggers should be adjusted. In certain embodiments, the constant is set lower for sports queries and higher for other queries.

One embodiment of the system includes microblogs in search results for as long as the model tells it that the microblog count is spiking, and for an additional number of hours, e.g., for 2 hours, after the last time at which the microblog count was spiking.

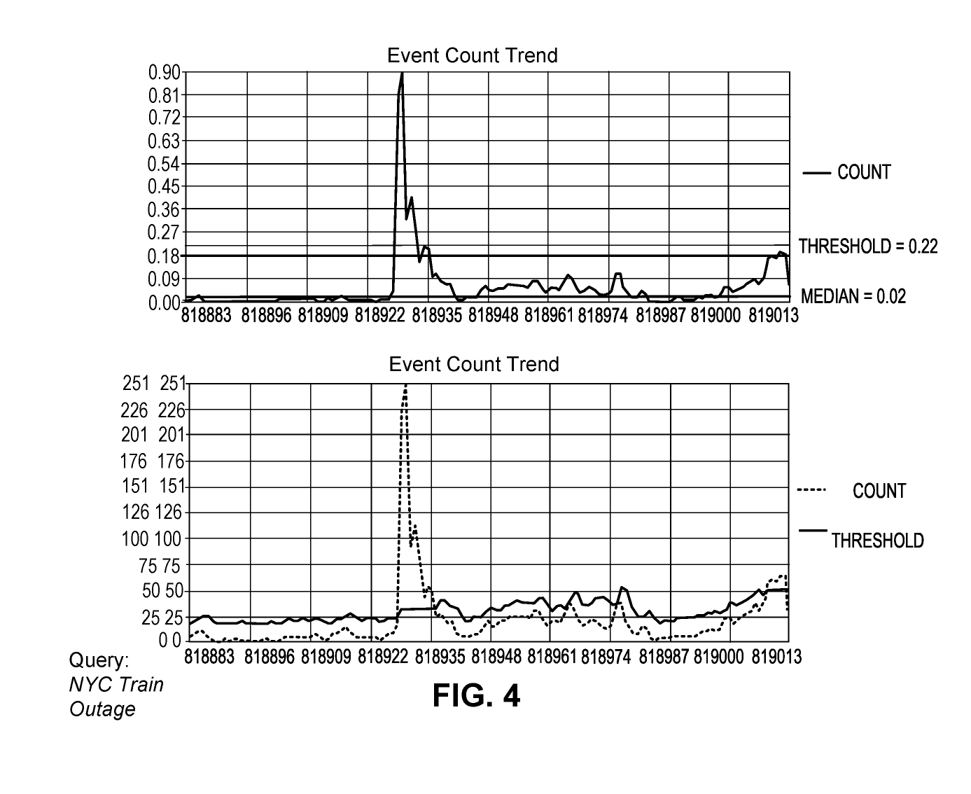

FIG. 4 shows two graphs of event count times series data for events, e.g., social media data such as tweets, that match a query, e.g., a query for “NYC train outage.” The top graph shows an approach that uses a trigger threshold equal to (median+iqr multiplier*iqr), where the median is a median of a microblog counts for microblogs matching the specified query for a specified recent period (e.g., the past several days), iqr—its interquartile range, and iqr multiplier is a constant. The bottom graph uses the residual method shown in FIG. 2. As can be seen in FIG. 4, the method of FIG. 2 provides earlier detection and more detection of spikes in microblog counts associated with the query “NYC train outage.”

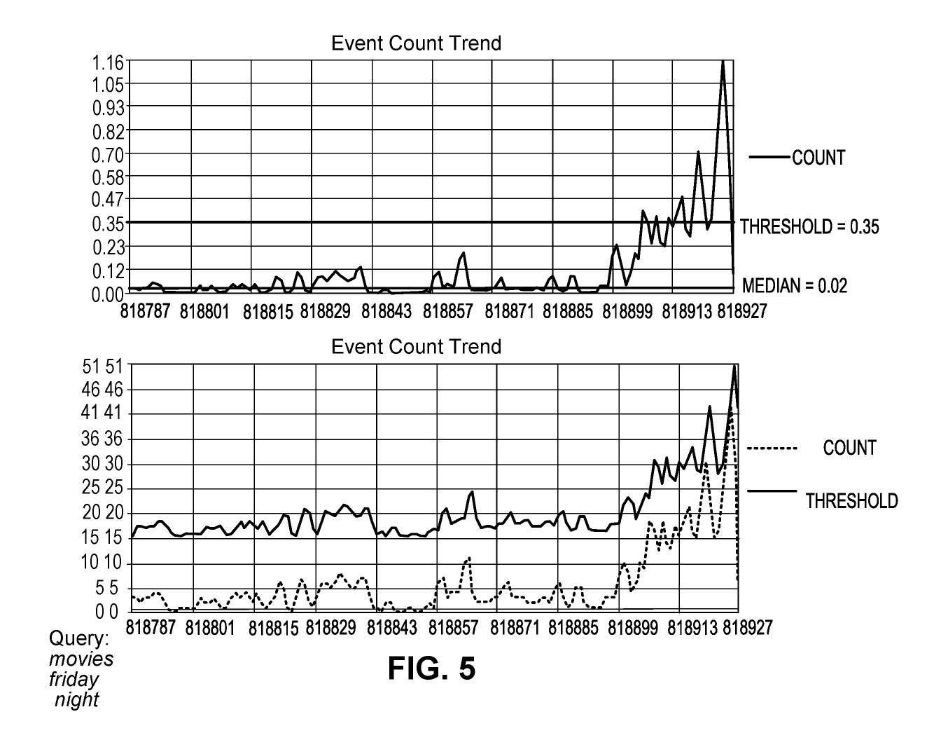

FIG. 5 shows two graphs of event count times series data for events, e.g., social media data such as tweets, that match a query where the graphs reveal the avoidance of triggering for slower increases when using the method of FIG. 2. Again the top graph shows an approach that uses a trigger threshold equal to (median+iqr multiplier*iqr). As can be seen in the bottom graph of FIG. 5, the method of FIG. 2 may not trigger, e.g., notification of a user or inclusion of microblog content in search results, if the increase in counts is predictable whereas the method used for the top graph will trigger under certain circumstances even if the increase in microblog counts is predictable.

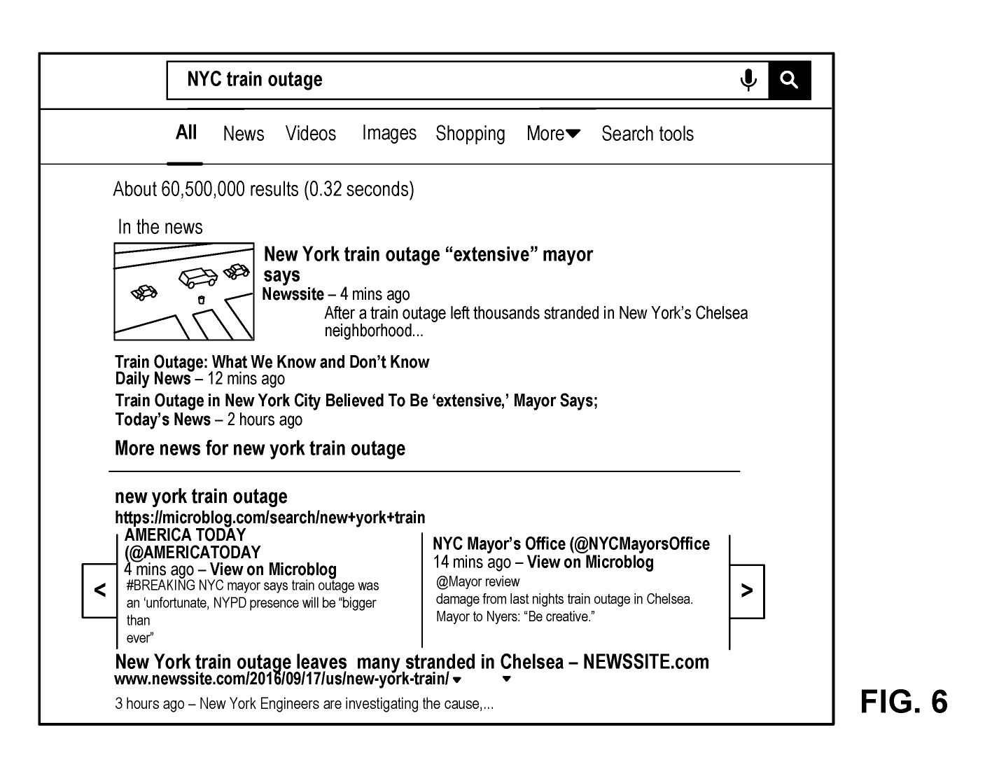

Once a triggering (e.g., inclusion of microblog content in search results) occurs, one embodiment of the relevancy analysis engine 110 of FIG. 1 forwards, to a search engine front end which in turn forwards to a user device, for display data representing microblog content as part of search results for the query. FIG. 6 is an example of a social media carousel shown embedded in a search results page that is a result of the operation of certain embodiments.

A query is not required by certain embodiments of the invention to initiate the process of detecting a spike in near real-time content associated with a topic. As long as a topic of interest is obtained in some way, embodiments of the systems and methods described in this specification can be used to accurately notify a user of an event when content about the event is spiking. Such accurate notification can be reflected in application metrics, e.g., user engagement metrics.

Embodiments can also restrict the microblog count time series to a specific location. Microbloggers often maintain public profiles that include a location of the microblogger. Furthermore, embodiments can use the microblogger's location and the query to identify hashtags that are relevant, e.g., if there is an earthquake in San Francisco and the user searches for San Francisco, the system can expand retrieval of microblog content to include content associated with related hashtags such as #sfearthquake.

Also near real-time event counts can include a variety of types of data in addition to microblog counts including social media counts and other publications, e.g., scholarly publications or news publications. These other types of near real-time data can be used in addition to or instead of the microblog data.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network. The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers. Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
one or more computers and one or more storage devices on which are stored instructions that are operable, when executed by the one or more computers, to cause the one or more computers to perform operations comprising:
(a) obtaining an historical time distribution of event counts associated with a topic for a relevant time period;
(b) extracting a predictable portion of the historical time distribution of event counts to produce a residual event count time distribution including residual event counts at successive times;
(c) determining a residual triggering threshold based on the residual event count time distribution; and
(d) taking an action when a residual event count exceeds the residual triggering threshold.

2. The system of claim 1 wherein the action is providing a notification to a user of a spike in event counts associated with the topic.

3. The system of claim 1 wherein the event is a microblog and the action is forwarding data to display microblog data as part of search results.

4. A system comprising:
one or more computers and one or more storage devices on which are stored instructions that are operable, when executed by the one or more computers, to cause the one or more computers to perform operations comprising:
(a) receiving a query;
(b) obtaining a microblog count time series for microblogs associated with the query for a relevant time period;
(c) extracting a predictable portion of the microblog count time series to produce a residual time series, the residual time series including residual microblog counts at successive times;
(d) determining a residual triggering threshold based on the residual time series; and
(e) forwarding for display data representing microblog content as part of search results for the query when a residual microblog count exceeds the residual triggering threshold.

5. The system of claim 4, wherein a machine learning model predicts the predictable portion of the microblog count time series.

6. The system of claim 4, wherein the operations further comprise not including the microblog content as part of search results for the query a specified time after the excess microblog count falls below the threshold.

7. The system of claim 4, wherein the microblog counts are tweet counts.

8. The system of claim 4, wherein determining a residual triggering threshold is based at least in part on median of the residual time series and a measure of the variance of the residual time series.

9. The system of claim 4, wherein the operations further comprise incorporating user interaction with provided microblog content in determining whether to provide additional microblog content as part of search results for a query.

10. The system of claim 4, wherein the method further comprises restricting the microblog count time series to microblogs from a particular location.

11. A computer-implemented method comprising:
(a) receiving a query;
(b) obtaining a microblog count time series for microblogs associated with the query for a relevant time period;
(c) extracting a predictable portion of the microblog count time series to produce a residual time series, the residual time series including residual microblog counts at successive times;
(d) determining a residual triggering threshold based on the residual time series; and
(e) forwarding for display data representing microblog content as part of search results for the query when a residual microblog count exceeds the residual triggering threshold.

12. The method of claim 11, the method further comprising not including the microblog content as part of search results for the query a specified time after the excess microblog count falls below the threshold.

13. The method of claim 11, wherein the microblog counts are tweet counts.

14. The method of claim 11, wherein the relevant time period is between 1 and 7 days.

15. The method of claim 11, wherein a machine learning model predicts the predictable portion of the microblog count time series.

16. The method of claim 11, wherein determining a residual triggering threshold is based at least in part on a median of the residual time series and a measure of the variance of the residual time series.

17. The method of claim 11, wherein the method further comprises communicating to a user a confidence metric that the residual microblog count reflects an event for which a user should be notified, the confidence metric based at least in part on the degree to which the residual microblog count exceeds the triggering threshold.

18. The method of claim 11, wherein the method further comprises incorporating user interaction with provided microblog content in determining whether to provide additional microblog content as part of search results for a query.

19. The method of claim 11, wherein the method further comprises restricting the microblog count time series to microblogs from a particular location.

20. The method of claim 11, the method further comprises:
(a) determining the median of the microblog count for the relevant time period;
(b) determining a variability measure of the variability the microblog count over the relevant time period
(c) determining a second triggering threshold based at least in part on the median and the variability measure; and
(d) displaying the carousel if either the microblog count exceeds the residual triggering threshold or the second triggering threshold.
